(19) United States
(12) Patent Application Publication
(10) Pub. No.: US 2007/0005703 A1
(43) Pub. Date: Jan. 4, 2007

(54) Methods, systems, devices and computer program products for conducting a text messaging conversation using multiple devices

(75) Inventor: Matti I. Vesterinen, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/147,850

(22) Filed: Jun. 8, 2005

(51) Int. Cl. G06F 15/16

(52) U.S. Cl. 709/206

(57) ABSTRACT

A method, computer program product, digital device and system for continuing a text messaging conversation on one device, where the conversation was previously established with another party using another device, are provided. A method, computer program product, digital device and system for notifying a user, on one device, of one or more text messages sent by another party to the user as part of an ongoing text messaging conversation with the other party conducted using a different device are also provided.

### FIELD OF THE INVENTION

This invention relates to text messaging, and more particularly to the use of multiple devices to conduct an Instant Messaging (IM) conversation.

### BACKGROUND OF THE INVENTION

Instant Messaging (IM) is the exchange of messages in realtime between two or more people. Unlike a dial-up system, such as the telephone, IM requires that both parties be logged onto their respective IM services at the same time. Also known as “chatting,” IM has become very popular for both business and personal use. Popular IM services on the public Internet include MSN Messenger, AOL Instant Messenger, Yahoo! Messenger, .NET Messenger Service and ICQ. Examples of IM standards include XMPP (Extensible Messaging and Presence Protocol) and SIP/SIMPLE (SIP (Session Initiation Protocol) for Instant Messaging and Presence Leveraging Extensions).

Currently, however, it is difficult for a user to change back and forth between various devices operated by the user using the same IM service (i.e., logging onto the IM service using the USER ID). In particular, it is difficult for a user to change devices, or leave a particular device, in the midst of an ongoing text messaging conversation in such a manner as to continue the text messaging conversation on a different device than that upon which the text messaging conversation began. A need, therefore, exists for an improved means of switching devices using the same IM service during an ongoing IM conversation such that the same IM conversation can continue following the switch of devices.

### BRIEF SUMMARY OF THE INVENTION

Generally described, various exemplary embodiments of the present invention provide an improvement over the known prior art by providing an improved means by which a user can continue a text messaging conversation on one device, i.e., a subsequent device, where the conversation was previously conducted using another device, i.e., a first device. In particular, exemplary embodiments of the present invention allow the user to first view, on the subsequent device, text messages he or she previously sent or received as part of the text messaging conversation using the first device, prior to continuing the conversation using the subsequent device. Exemplary embodiments of the present invention further provide an improvement over the known prior art by providing a means by which a user can be notified on one device that a text message has been sent by another party as part of an ongoing text messaging conversation the user was conducting using a different device. In various embodiments, a determination of which device will be used to continue the previously established text messaging conversation and/or to receive the notification that a text message has been received as part of an ongoing conversation is based on the priority levels assigned to the various devices operated by the user. These priority levels may vary based on, for example, which devices are logged into the text messaging service; which devices are shut down; the status of respective devices; and/or where the respective devices are located.

According to one aspect of the present invention a method of continuing a text messaging conversation on a second device, which was previously established with another party using a first device, is provided. In one exemplary embodiment, the method includes: (1) establishing the text messaging conversation with the other party using the first device; and (2) automatically continuing the text messaging conversation with the other party using the second device, if a priority level associated with the second device exceeds a priority level associated with the first device. Automatically continuing the text messaging conversation may include displaying, on the second device, one or more text messages of the text messaging conversation conducted with the other party using the first device.

In one exemplary embodiment, the priority level associated with the first device decreases when a text messaging service, to which the first device was logged on, is notified that the first device is no longer available to receive text messages, and/or when the first device logs out of the text messaging service. In other exemplary embodiments, the priority levels associated with the first and second devices vary based on the status of respective first and second devices and/or the respective locations of the first and second devices.

According to another aspect of the present invention a method of notifying a user of one or more text messages sent by another party to the user as part of an ongoing text messaging conversation with the other party using a first device is provided. In one exemplary embodiment, the method includes: (1) establishing the text messaging conversation with the other party using the first device; and (2) automatically notifying the user, on a second device, that a text message has been sent by the other party to the user, if a priority level associated with the second device exceeds a priority level associated with the first device.

According to yet another aspect of the present invention, a computer program product for continuing a text messaging conversation on a second device, which was previously established with another party using a first device, is provided. In one exemplary embodiment, the computer program product includes at least one computer-readable storage medium having computer-readable program code portions stored therein. These computer-readable program code portions may include: (1) a first executable portion for establishing the text messaging conversation with the other party using the first device; and (2) a second executable portion for automatically continuing the text messaging conversation with the other party using the second device if a priority level associated with the second device exceeds a priority level associated with the first device. In one exemplary embodiment, automatically continuing the text messaging conversation comprises displaying, on the second device, one or more text messages of the text messaging conversation conducted with the other party using the first device.

According to another aspect of the present invention a computer program product for notifying a user of one or more text messages sent by another party to the user as part of an ongoing text messaging conversation with the other party using a first device is provided. In one exemplary embodiment, the computer program product comprises at least one computer-readable storage medium having computer-readable program code portions stored therein. The computer program code portions may include: (1) a first executable portion for establishing the text messaging conversation with the other party using the first device; and (2) a second executable portion for automatically notifying the user, on a second device, that a text message has been sent by the other party to the user, if a priority level associated with the second device exceeds a priority level associated with the first device.

According to one aspect of the present invention a digital device capable of continuing a text messaging conversation, which was previously established with another party using a first digital device, is provided. In one exemplary embodiment the digital device includes a display; a processor in communication with the display; and a memory module in communication with the processor that stores an application executable by the processor, wherein the application is capable, upon execution, of displaying, on the digital device display, one or more text messages of the text messaging conversation conducted on the first digital device upon a determination that a priority level associated with the digital device exceeds a priority level associated with the first digital device.

In one exemplary embodiment, the application is further capable of automatically logging the digital device into a text messaging service upon a determination that the priority level associated with the digital device exceeds the priority level associated with the first digital device. In another exemplary embodiment, the application is further capable of automatically placing the digital device in sleep mode when the priority level associated with the first digital device exceeds the priority level of the digital device, and of placing the digital device in active mode when the priority level associated with the digital device exceeds the priority level associated with the first digital device.

According to another aspect of the present invention a digital device capable of notifying a user of the digital device that a text message has been sent by another party to the user as part of an ongoing text messaging conversation with the other party on a first digital device is provided. In one exemplary embodiment, the digital device includes a display; a processor in communication with the display; and a memory module in communication with the processor that stores an application executable by the processor, wherein the application is capable, upon execution, of automatically notifying the user that a text message has been sent by the other party to the user upon a determination that a priority level associated with the digital device exceeds a priority level associated with the first digital device.

According to yet another aspect of the present invention a system for continuing a text messaging conversation on a second device, which was previously established with another party using a first device, is provided. In one exemplary embodiment, the system includes: (1) a means for establishing the text messaging conversation with the other party using the first device; and (2) a means for continuing the text messaging conversation with the other party using the second device if a priority level associated with the second device exceeds a priority level associated with the first device. In one exemplary embodiment, automatically continuing the text messaging conversation comprises displaying, on the second device, one or more text messages of the text messaging conversation conducted with the other party using the first device.

According to another aspect of the present invention a system for notifying a user of one or more text messages sent by another party to the user as part of an ongoing text messaging conversation with another party using a first device is provided. In one exemplary embodiment, the system includes: (1) a means for establishing the text messaging conversation with the other party using the first device; and (2) a means for automatically notifying the user, on the second device, that a text message has been sent by the other party to the user, if a priority level associated with the second device exceeds a priority level associated with the first device.

### BRIEF DESCRIPTION OF THE DRAWING

Having thus described the invention in general terms, reference will now be made to the accompanying drawing, which are not necessarily drawn to scale, and wherein:

FIG. 1 is a block diagram of a system that would benefit from embodiments of the present invention;

FIG. 2 is a schematic block diagram of a mobile station capable of operating in accordance with an embodiment of the present invention;

FIG. 3 is a flow chart illustrating the steps taken when continuing a text messaging conversation on a digital device, where the conversation was previously established with another party using a different digital device, in accordance with an exemplary embodiment of the present invention; and

FIG. 4 is a flow chart illustrating the steps taken when notifying a user, on one digital device, that a text message has been sent by another party to the user as part of an ongoing text messaging conversation conducted on a different digital device, in accordance with an exemplary embodiment of the present invention.

### DESCRIPTION OF THE INVENTION

The present inventions now will be described more fully hereinafter with reference to the accompanying drawing, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overview:

Exemplary embodiments of the present invention provide an improved means of conducting a text messaging conversation using multiple devices operated by the same user. In particular, one exemplary embodiment allows a user to view one or more text messages, which he or she sent to and/or received from another party pursuant to a text messaging conversation conducted using one device, on another device, prior to using the other device to continue the conversation. This is beneficial because it allows the user to switch between various devices operated by the user without losing the general flow of the conversation. The user is, therefore, able to go back and review the messages he or she sent and/or received throughout the conversation whenever he or she desires to do so, while having the flexibility to switch between devices during the conversation. In one exemplary embodiment, this is done automatically when a priority level associated with the subsequent device exceeds that of the initial device on which the conversation was conducted. As discussed in more detail below, the priority level associated with each device may vary depending upon, for example, whether the user is logged into an Instant Messaging (IM) service using that device; whether the user has manually changed the status of the device, for example by locking his or her computer or closing a conversation window displayed on the computer; whether the device is currently on; and/or the location of the device with respect to the other devices.

Similarly, another exemplary embodiment enables a user to receive a notification on whatever device he or she is currently using (or whatever device has the highest priority) that a text message has been sent by another party to the user as part of an ongoing text messaging conversation the user was previously conducting on some other device. This is beneficial because it enables the user to, for example, leave his or her computer or lap top and begin using another device, yet still be aware of incoming messages from someone with which the user was previously corresponding. In one exemplary embodiment, the notification merely tells the user that a message has been sent, and the user must then go back to the original device to view the message. The notification may be by any known means such as, for example, a text message stating that the message has been sent or a vibration generated in the subsequent device. In another exemplary embodiment, the notification includes the text message itself. In this case, the user is able to view the text message sent by the other party using either the original device or the subsequent device. As in the embodiments discussed above, the notification may be sent automatically based on the various priority levels associated with respective digital devices operated by the user.

In other exemplary embodiments, in addition to sending either all previous text messages from the ongoing text messaging conversation, or a notification of an incoming message, to the new device, a message is sent to the other party notifying that party that the user has, or is in the process of, switching devices. This is beneficial because it puts the other party on notice that a reply from the user may take slightly longer than usual.

System and Terminal Architecture:

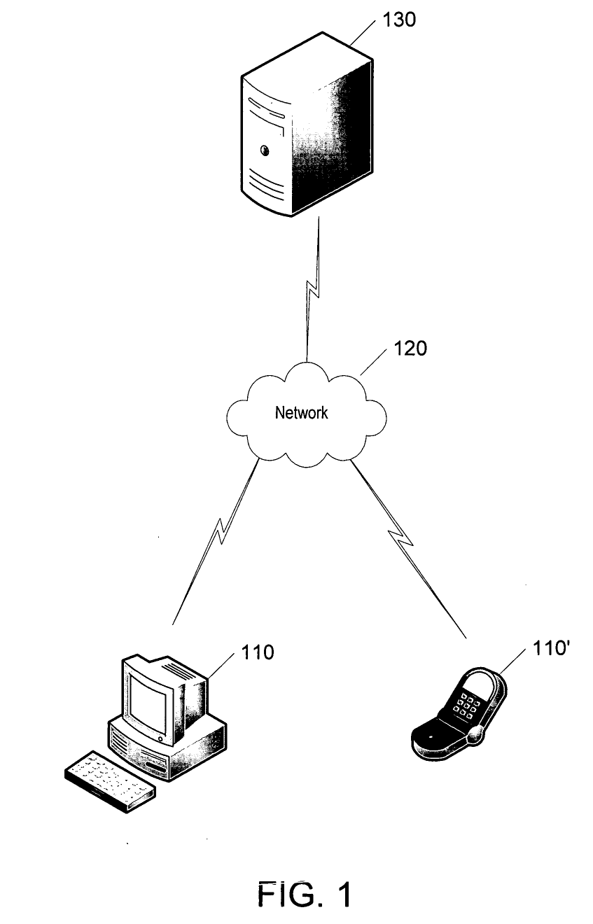

Referring to FIG. 1, an illustration of one type of system that would benefit from the present invention is provided. As shown, the system may include any two or more digital devices 110, 110′ operated by a user, including, for example, a cellular telephone, portable digital assistant (PDA), pager, personal computer (PC), laptop, or tablet, or any other communication device capable of sending and/or receiving data. These devices are connected to an Instant Messaging (IM) server 130 via a data network 120, such as, for example, a local area network (LAN), metropolitan area network (MAN), and/or a wireless area network (WAN), for the purpose of sending and receiving instant messages to or from various other digital devices that are operated by other parties and are similarly connected to the data network 120.

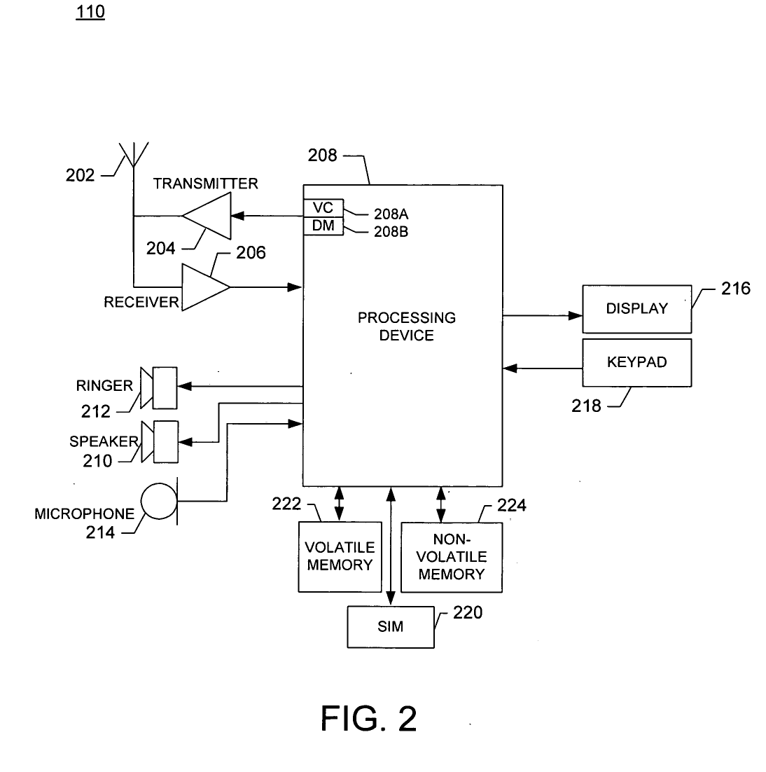

In one exemplary embodiment, at least one of the digital devices 110 used to send and receive instant messages by the user may be a mobile terminal, or mobile station, shown in detail in FIG. 2. The mobile terminal, or other digital device, includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 2, the entity can include an antenna 202, a transmitter 204, a receiver 206, and means, such as a processing device 208, e.g., a processor, controller or the like, that provides signals to and receives signals from the transmitter 204 and receiver 206, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 208, such as a processor, controller or other computing device, includes the circuitry required for implementing the video, audio, and logic functions of the mobile station and is capable of executing application programs for implementing the functionality discussed below. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 208 thus also includes the functionality to convolutionally encode and interleave message and data prior to modulation and transmission. The processing device can additionally include an internal voice coder (VC) 208A, and may include an internal data modem (DM) 208B. Further, the processing device 208 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP) for example.

The mobile station may also comprise means such as a user interface including, for example, a conventional earphone or speaker 210, a ringer 212, a microphone 214, a display 216, all of which are coupled to the controller 208. The user input interface, which allows the mobile device to receive data, can comprise any of a number of devices allowing the mobile device to receive data, such as a keypad 218, a touch display (not shown), a microphone 214, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 220, a removable user identity module (R-UIM) (not shown), or the like, which typically stores information elements related to a mobile subscriber. In addition to the SIM, the mobile device can include other memory. In this regard, the mobile station can include volatile memory 222, as well as other non-volatile memory 224, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for enabling the mobile station to automatically continue a text messaging conversation that was previously established using a different digital device, such as a lap top or another mobile station, when the mobile station takes on a higher priority level than the preceding device. This may be done, for example, by automatically displaying one or more text messages of the text messaging conversation conducted on the preceding device on the mobile station display. In another embodiment, the memory may store computer program code for enabling the mobile station to automatically notify the user that a text message has been sent by another party as part of an ongoing text messaging conversation conducted with the other party using a different device. This may be done upon a determination that the priority level associated with the preceding device dropped below that of the mobile station.

The system, method, device and computer program product of exemplary embodiments of the present invention are primarily described in conjunction with mobile communications applications. It should be understood, however, that the system, method, device and computer program product of embodiments of the present invention can be utilized in conjunction with a variety of other applications, both in the mobile communications industries and outside of the mobile communications industries. For example, the system, method, device and computer program product of embodiments of the present invention can be utilized in conjunction with wireline and/or wireless network (e.g., Internet) applications including, for example, in embodiments in which an ongoing conversation is transferred to a fixed, wireline device.

Also, it should be understood that while the terminal was illustrated and described as comprising a mobile telephone, mobile telephones are merely illustrative of one type of terminal that would benefit from the present invention and, therefore, should not be taken to limit the scope of the present invention. While several embodiments of the terminal are illustrated and described for purposes of example, other types of terminals, such as portable digital assistants (PDAs), pagers, laptop computers, tablets, and other types of electronic systems including both mobile, wireless devices and fixed, wireline devices, can readily employ embodiments of the present invention.

Methods of Using Multiple Devices when Conducting Text Messaging Conversation:

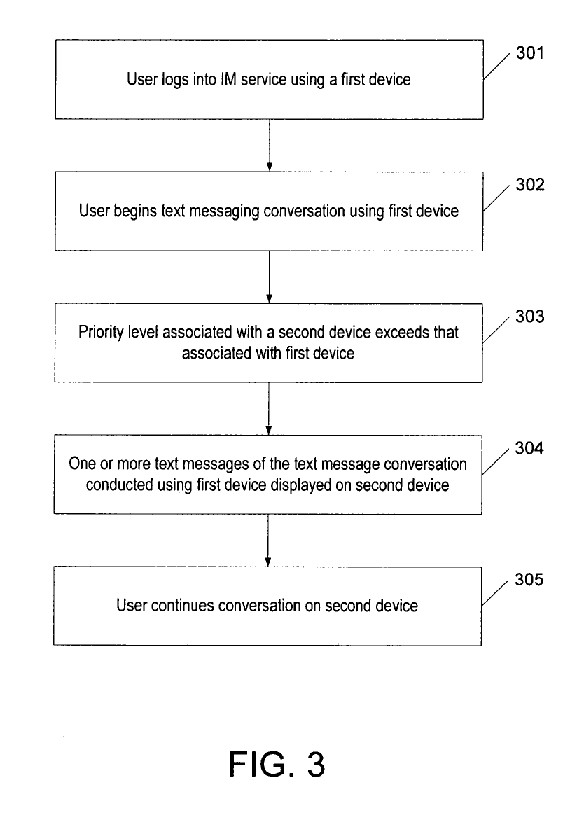

FIG. 3 is a flow chart illustrating the steps taken when conducting a text messaging conversation using more than one device, in accordance with an exemplary embodiment of the present invention. As shown, the process begins at Step 301 where the user logs onto an IM service using a first device, such as the mobile terminal of FIG. 2. In one embodiment, logging onto an IM service requires the user to enter both a USER ID and a PASSWORD, wherein each of which have been previously established by the user in conjunction with a user account. This enables the IM service to associate the current device with the user's account information and, for example, to begin charging the user's account for the time spent logged onto the service. Once the user has logged onto the IM service using his or her first device, the user begins a text messaging conversation with another party using the first device (Step 302). In one exemplary embodiment, this involves opening an IM window on the user's device display and sending and receiving messages using the IM window. In one embodiment the IM window is divided into two sections, namely a top and a bottom section. The bottom section displays the text of messages the user is in the process of sending as the user enters them, while the top section displays the text of all text messages once they have been sent and/or received. In a typical embodiment, the text messages are preceded by the USER ID of the party that sent the message, thus enabling the user to distinguish between messages he or she sent and messages he or she received. In one exemplary embodiment, it is possible for the user to open multiple IM windows, and, therefore, to concurrently conduct multiple IM conversations using a single device.

At some point in the conversation (i.e., before the conversation is “completed”), a priority level associated with another device operated by the user, namely a second device, exceeds that of the first device (i.e., the device the user is currently using to conduct the text messaging conversation) (Step 303). This may be caused by either a change in the priority level associated with the first device (i.e., it decreases), or a change in the priority level associated with the second device (i.e., it increases). In one embodiment, a conversation is “completed” where a user closes the conversation window on his or her digital device, shuts down the digital device on which he or she was conducting the conversation, or logs out of the IM service using that device. Alternatively, in another exemplary embodiment, the conversation would not be considered “completed” where a text message associated with the same USER ID was sent by the same party with which the user was previously conducting the conversation within some predefined period of time from when the last text message was sent or received, regardless of whether the user's conversation window is closed, or his or her digital device on which the conversation was conducted was shut down or logged off of the IM service.

Various triggers may cause the priority level of a device to change with respect to the priority levels associated with other devices operated by the user. For example, where a user logs out of the IM service using the current (or first) device, the priority level of that device would decrease, since the device would no longer be available to receive text messages. Similarly, where the current device is shut down the priority level would again decrease for the same reason. In exemplary embodiments, the user may affect the priority level of the device by changing the “status” of the device. For example, the user may indicate that he or she is away from the device, or that he or she is unavailable to receive text messages at that time. Similarly, the user may close the IM window on his or her device, which may result in a decreased priority. Location or other context information relating to the device may also affect the device's priority level. For example, the user's IM account may specify that his or her cellular telephone should have a higher priority when the cellular telephone is located in specifically enumerated cells. The priority level associated with the cellular telephone would, therefore, increase as the cellular telephone enters those enumerated cells.

In Step 304, one or more text messages of the text messaging conversation conducted using the first device are then displayed on the second device having the higher priority. In one exemplary embodiment, the user had previously logged the second device into the IM service using the same USER ID and PASSWORD as the first device. This may have been done either prior to beginning the text messaging conversation with the other party or at some point during the conversation. In this embodiment, the second device was, in essence, “asleep” (or in sleep mode) up to the point where its priority level exceeded that of the first device. In other words, the second device was logged onto the service, but did not receive any of the incoming text messages. When the priority level of the first device dropped below that of the second, the second device automatically “woke up” (or changed to active mode) and displayed the previously sent and received messages pursuant to the ongoing conversation.

In another exemplary embodiment, logging into the IM service is what caused the second device's priority level to exceed that of the first device. This may be the case, for example, where a laptop is the second device and the user has specified that anytime he or she is logged into the IM service using his or her laptop, for example, the laptop should always receive the incoming text messages (i.e., the laptop should have the highest priority relative to the other devices). In yet another exemplary embodiment, the second device is configured to automatically log into the IM service when its priority level exceeds that of the first device.

Finally, in Step 305, the user will continue to conduct the conversation using the second device. As stated above, exemplary embodiments of the present invention make this easier by providing the user with all of the previously sent and received text messages relating to the conversation.

In the exemplary embodiments discussed above, priority may be monitored at various places in the system. For example, in one exemplary embodiment, the IM server 130 will continuously (or at regular intervals) check the priority status of the various devices associated with the user. If at some point the priority level associated with the device currently being used by the user to conduct a text messaging conversation drops below that of another device, either because of a decrease in the priority level associated with the current device or an increase in the priority level associated with the new device, the IM server will gather the text messages making up the ongoing conversation, which in one embodiment may be stored in a database accessible by the IM server, and forward those text messages to the other device. The IM server would further then direct all subsequent text messages to the new device, provided the priority level associated with that device remains higher.

While the previously described exemplary embodiments were described in relation to continuing a conversation on a second device where the conversation was started on a first device, one of ordinary skill in the relevant art will recognize that the present invention is not limited to this specific scenario. In contrast, exemplary embodiments of the present invention can be used to continue a conversation on a third (or fourth or fifth, etc.) device after the conversation was started on a first and continued on a second. In other words, exemplary embodiments of the present invention relate to enabling a user to change back and forth between various devices operated by the user throughout an ongoing text messaging conversation with another party. They are not limited to the situation where a user changes from the first device to a second device, wherein the “first” device is the device that originated the conversation.

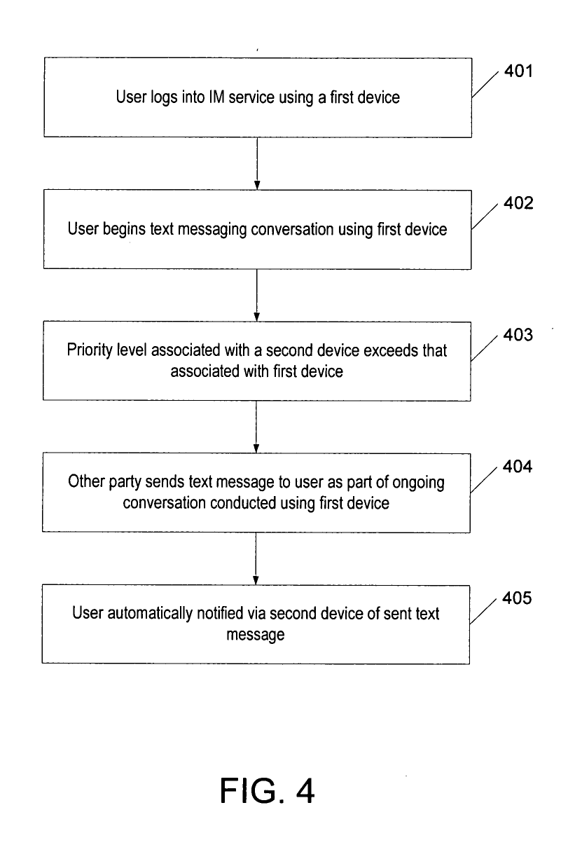

FIG. 4 illustrates the steps taken when notifying a user, on one device, that a text message has been sent by another party to the user as part of an ongoing text messaging conversation conducted using a different device, in accordance with exemplary embodiments of the present invention. As shown in FIG. 3, the process begins where the user logs into the IM service using a first device (Step 401) and begins a text messaging conversation with another party using the first device (Step 402). As above, at some point during the conversation the priority level associated with another device operated by the user exceeds that associated with the first device for reasons similar to those discussed above (Step 403).

In Step 404, the other party sends a text message to the user pursuant to the ongoing text messaging conversation. However, because the priority level of the second device exceeds that of the first device, this indicates that the message should not just be sent to the first device. Some other notification or action should be taken. In exemplary embodiments of the present invention, the action taken is to notify the user on his or her second device (i.e., the device having the higher priority) that a text message has been sent by the other party to the user (Step 405). In one exemplary embodiment the notification consists of a text message stating, for example, “You have received a text message from ______,” with the USER ID of the other party inserted in the blank. In other exemplary embodiments, the notification may consist of a vibration or tone generated in the second device, or any other similar means of getting the user's attention. In any of these embodiments, the user may interpret this notification as requiring him to then go to the first device to view the incoming text message. In another exemplary embodiment, the text message will also be displayed on the second device for the user to view.

As discussed above, monitoring of the priority of each device associated with a user may be done, for example, by the IM server 130. The IM server may, therefore, be responsible for periodically verifying the priority levels associated with the various devices and notifying the appropriate devices of incoming text messages accordingly.

In exemplary embodiments of the present invention, in addition to either displaying one or more text messages of the conversation conducted using the first device on the new device (as described in connection with FIG. 3) or notifying the user on the new device of an incoming text message pursuant to a previously established conversation (as discussed in connection with FIG. 4), where the priority level associated with a new device exceeds that of the device currently being used by the user, a message may be sent to the party with which the user is communicating alerting that party to the fact that the user has, or is in the process of, switching devices. This message may be sent, or caused to be sent, by the first device, the second device, the IMS server, or any other network entity in communication with the various devices.

As will be appreciated by one skilled in the art, the embodiments of the present invention described above may be embodied as a system, method, mobile terminal device or other apparatus, or computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of web-implemented computer software. Any suitable computer-readable storage medium may be utilized including hard disks, CD-ROMs, optical storage devices, or magnetic storage devices.

The present invention is described above with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks, although other means for implementing the functions including various combinations of hardware, firmware and software as described herein may also be employed.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of continuing a text messaging conversation on a second device, which was previously established with another party using a first device, said method comprising:
establishing the text messaging conversation with the other party using the first device; and
automatically continuing the text messaging conversation with the other party using the second device if a priority level associated with the second device exceeds a priority level associated with the first device, wherein automatically continuing the text messaging conversation comprises displaying, on the second device, one or more text messages of the text messaging conversation conducted with the other party using the first device.

2. The method of claim 1, wherein establishing the text messaging conversation comprises logging into a text messaging service using the first device.

3. The method of claim 2, wherein prior to continuing the text messaging conversation using the second device, the method comprises:
logging into the text messaging service using the second device.

4. The method of claim 3, wherein the second device automatically logs into the text messaging service when the priority level associated with the second device exceeds the priority level associated with the first device.

5. The method of claim 3, wherein logging into the text messaging service using the first device comprises identifying the first device with a first user identification (ID), wherein logging into the text messaging service using the second device comprises associating the second device with a second user ID, and wherein the first user ID is the same as the second user ID.

6. The method of claim 3, wherein the priority level associated with the first device decreases when the text messaging service is notified that the first device is no longer available to receive text messages.

7. The method of claim 3, wherein the priority level associated with the first device decreases when the first device logs out of the text messaging service.

8. The method of claim 3, wherein the respective priority levels associated with the first and second devices vary based on a status associated with respective first and second devices.

9. The method of claim 3, wherein the respective priority levels associated with the first and second devices vary based on the respective locations of the first and second devices.

10. The method of claim 1 further comprising:
displaying one or more subsequent text messages sent and received using the second device on the first device.

11. The method of claim 1 further comprising:
transmitting a message to the other party indicating that the user is switching from the first device to the second device.

12. A method of notifying a user of one or more text messages sent by another party to the user as part of an ongoing text messaging conversation with the other party using a first device, said method comprising:
establishing the text messaging conversation with the other party using the first device; and
automatically notifying the user, on a second device, that a text message has been sent by the other party to the user, if a priority level associated with the second device exceeds a priority level associated with the first device.

13. The method of claim 12, wherein establishing the text messaging conversation with the other party using the first device comprises logging into a text messaging service using the first device.

14. The method of claim 13, wherein prior to automatically notifying the user, on a second device, that a text message has been sent by the other party to the user, the method further comprises:
automatically lowering the priority level associated with the first device when the text messaging service is notified that the first device is no longer available.

15. The method of claim 14, wherein the text messaging service is automatically notified that the first device is no longer available when the first device is shut down.

16. The method of claim 14, wherein the text messaging service is automatically notified that the first device is no longer available when a conversation window on the first device is closed.

17. The method of claim 12, wherein the respective priority levels associated with the first and second devices vary based on a status associated with respective first and second devices.

18. The method of claim 12, wherein the respective priority levels associated with the first and second devices vary based on the respective locations of the first and second devices.

19. The method of claim 12, wherein prior to automatically notifying the user, on the second device, that a text message has been sent by the other party to the user, the method further comprises:
logging into the text messaging service using the second device, wherein the second device automatically logs into the text messaging service upon receiving notification that the priority level associated with the second device exceeds the priority level associated with the first device.

20. The method of claim 19, wherein logging into the text messaging service using the first device comprises identifying the first device with a first user identification (ID), wherein logging into the text messaging service with the second device comprises associating the second device with a second user ID, and wherein the first user ID is the same as the second user ID.

21. The method of claim 12, wherein automatically notifying the user, on a second device, that a text message has been sent by the other party to the user comprises generating and displaying a text message on the second device stating that a new text message has been sent by the other party to the user and can be viewed using the first device.

22. The method of claim 12, wherein automatically notifying the user, on a second device, that a text message has been sent by the other party to the user comprises generating a vibration or tone in the second device.

23. The method of claim 12, wherein the text message sent by the other party to the user is displayed on the first device.

24. The method of claim 23, wherein the text message sent by the other party to the user is further displayed on the second device.

25. The method of claim 12 further comprising:
transmitting a message to the other party indicating that the user is switching from the first device to the second device.

26. A computer program product for continuing a text messaging conversation on a second device, which was previously established with another party using a first device, wherein the computer program product comprises at least one computer-readable storage medium having computer-readable program code portions stored therein, the computer-readable program code portions comprising:
a first executable portion for establishing the text messaging conversation with the other party using the first device; and
a second executable portion for automatically continuing the text messaging conversation with the other party using the second device if a priority level associated with the second device exceeds a priority level associated with the first device, wherein automatically continuing the text messaging conversation comprises displaying, on the second device, one or more text messages of the text messaging conversation conducted with the other party using the first device.

27. The computer program product of claim 26, wherein establishing the text messaging conversation comprises logging into a text messaging service using the first device.

28. The computer program product of claim 27 further comprising:
a third executable portion for logging into the text messaging service using the second device, wherein said second device logs into the text messaging service prior to the text messaging conversation being automatically continued using the second device.

29. The computer program product of claim 28, wherein the second device automatically logs into the text messaging service when the priority level associated with the second device exceeds the priority level associated with the first device.

30. The computer program product of claim 28, wherein logging into the text messaging service using the first device comprises identifying the first device with a first user identification (ID), wherein logging into the text messaging service using the second device comprises associating the second device with a second user ID, and wherein the first user ID is the same as the second user ID.

31. The computer program product of claim 28, wherein the priority level associated with the first device decreases when the text messaging service is notified that the first device is no longer available to receive text messages.

32. The computer program product of claim 28, wherein the priority level associated with the first device decreases when the first device logs out of the text messaging service.

33. The computer program product of claim 28, wherein the respective priority levels associated with the first and second devices vary based on the respective locations of the first and second devices.

34. A computer program product for notifying a user of one or more text messages sent by another party to the user as part of an ongoing text messaging conversation with the other party using a first device, wherein the computer program product comprises at least one computer-readable storage medium having computer-readable program code portions stored therein, the computer program code portions comprising:
a first executable portion for establishing the text messaging conversation with the other party using the first device; and
a second executable portion for automatically notifying the user, on a second device, that a text message has been sent by the other party to the user, if a priority level associated with the second device exceeds a priority level associated with the first device.

35. The computer program product of claim 34, wherein establishing the text messaging conversation with the other party using the first device comprises logging into a text messaging service using the first device.

36. The computer program product of claim 35 further comprising:
a third executable portion for automatically lowering the priority level associated with the first device when the text messaging service is notified that the first device is no longer available.

37. The computer program product of claim 36, wherein the text messaging service is automatically notified that the first device is no longer available when the first device is shut down.

38. The computer program product of claim 36, wherein the text messaging service is automatically notified that the first device is no longer available when a conversation window on the first device is closed.

39. The computer program product of claim 34, wherein the respective priority levels associated with the first and second devices vary based on the respective locations of the first and second devices.

40. The computer program product of claim 34 further comprising:
a third executable portion for logging into the text messaging service using the second device, wherein the second device automatically logs into the text messaging service upon receiving notification that the priority level associated with the second device exceeds the priority level associated with the first device.

41. The computer program product of claim 40, wherein logging into the text messaging service using the first device comprises identifying the first device with a first user identification (ID), wherein logging into the text messaging service with the second device comprises associating the second device with a second user ID, and wherein the first user ID is the same as the second user ID.

42. The computer program product of claim 34, wherein automatically notifying the user, on a second device, that a text message has been sent by the other party to the user comprises generating and displaying a text message on the second device stating that a new text message has been sent by the other party to the user and can be viewed using the first device.

43. The computer program product of claim 34, wherein automatically notifying the user, on a second device, that a text message has been sent by the other party to the user comprises generating a vibration or tone in the second device.

44. The computer program product of claim 34, wherein the text message sent by the other party to the user is displayed on the first device.

45. A digital device capable of continuing a text messaging conversation which was previously established with another party using a first digital device, said digital device comprising:
a display;
a processor in communication with the display; and
a memory module in communication with the processor that stores an application executable by the processor, wherein the application is capable, upon execution, of displaying, on the digital device display, one or more text messages of the text messaging conversation conducted on the first digital device upon a determination that a priority level associated with the digital device exceeds a priority level associated with the first digital device.

46. The digital device of claim 45, wherein the application is further capable of automatically logging the digital device into a text messaging service upon a determination that the priority level associated with the digital device exceeds the priority level associated with the first digital device.

47. The digital device of claim 45, wherein the application is further capable of automatically placing the digital device in sleep mode when the priority level associated with the first digital device exceeds the priority level of the digital device, and wherein the application is further capable of placing the digital device in active mode when the priority level associated with the digital device exceeds the priority level associated with the first digital device.

48. The digital device of claim 45, wherein the priority level associated with the first device decreases when the text messaging service is notified that the first device is no longer available to receive text messages.

49. The digital device of claim 45, wherein the priority level associated with the first device decreases when the first device logs out of the text messaging service.

50. The digital device of claim 45, wherein the respective priority levels associated with the first and second devices vary based on the respective locations of the first and second devices.

51. The digital device of claim 45, wherein the application is further capable of causing a message to be sent to the other party indicating that the user is switching from the first digital device to the digital device.

52. A digital device capable of notifying a user of the digital device that a text message has been sent by another party to the user as part of an ongoing text messaging conversation with the other party using a first digital device, said digital device comprising:
a display;
a processor in communication with the display; and
a memory module in communication with the processor that stores an application executable by the processor, wherein the application is capable, upon execution, of automatically notifying the user that a text message has been sent by the other party to the user upon a determination that a priority level associated with the digital device exceeds a priority level associated with the first digital device.

53. The digital device of claim 52, wherein the application is further capable of automatically logging the digital device into a text messaging service upon the determination that the priority level associated with the digital device exceeds the priority level associated with the first digital device.

54. The digital device of claim 52, wherein automatically notifying the user that a text message has been sent comprises generating a text message that states that a new text message has been sent by the other party to the user and displaying the generated text message on the digital device display.

55. The digital device of claim 52, wherein automatically notifying the user that a text message has been sent comprises generating a vibration or tone in the digital device.

56. A system for continuing a text messaging conversation on a second device, which was previously established with another party using a first device, said system comprising:
a means for establishing the text messaging conversation with the other party using the first device; and
a means for continuing the text messaging conversation with the other party using the second device if a priority level associated with the second device exceeds a priority level associated with the first device, wherein automatically continuing the text messaging conversation comprises displaying, on the second device, one or more text messages of the text messaging conversation conducted with the other party using the first device.

57. A system for notifying a user of one or more text messages sent by another party to the user as part of an ongoing text messaging conversation with another party using a first device, said system comprising:
a means for establishing the text messaging conversation with the other party using the first device; and
a means for automatically notifying the user, on the second device, that a text message has been sent by the other party to the user, if a priority level associated with the second device exceeds a priority level associated with the first device.
